(19) United States
(12) Patent Application Publication
(10) Pub. No.: US 2010/0028101 A1
(43) Pub. Date: Feb. 4, 2010

(54) Hot pressing process, particularly for providing metal unions for pneumatic, hydraulic and fluid-operated circuits, and metal union obtained thereby

(75) Inventor: Cesare Bottura, Brescia (IT)

Correspondence Address: MODIANO & ASSOCIATI, Via Meravigli, 16, Milano, 20123, IT

(73) Assignee: OLAB S.r.l.

(21) Appl. No.: 12/458,658

(22) Filed: Jul. 20, 2009

(30) Foreign Application Priority Data
Jul. 30, 2008 (EP) 08425525

(51) Int. Cl. F16B 39/00; C22F 1/04; C22F 1/05

(52) U.S. Cl. 411/190; 148/695; 148/694

(57) ABSTRACT

A hot pressing process, particularly for providing metal unions couplings for pneumatic, hydraulic and fluid-operated circuits, and a resulting metal union. The hot pressing process comprising:
a step of preheating aluminum alloy bars,
a step of pressing the part to be obtained,
a thermal hardening treatment, and
a thermal treatment for artificial aging.

The standard cycle further provides for a step of solubilization of the pressed part, performed between the step of pressing the part to be obtained and the thermal hardening treatment. The alloy preferably comprising (weight percent): Si 0.6-1.4%, Fe 0.7%, Cu 0.2-0.5%, Mn 0.2-1%, Mg 0.6-1.2%, Cr 0.3%, Zn 0.3%, Ti 0.2%, Pb 0.4%, Bi 0.5-1.5%, balance aluminum. The process can include a solutionising step after the pressing step.

The present invention relates to a hot pressing process, particularly for providing metal unions for pneumatic, hydraulic and fluid-operated circuits.

### BACKGROUND OF THE INVENTION

In the field of systems and in particular in the fields of shipbuilding and rail vehicle building, the need to provide interfacing and/or connecting components with high performance among the different components of the system is now routine.

More precisely, metal unions, typically made of brass and/or stainless steel alloys, are known which can be used at high operating pressures, up to ten times higher than the normal pressures used in the most widely spread systems.

The choice of the material is linked substantially to the technological process used to provide the union.

In fact, in order to obtain components that have a high mechanical performance and an excellent dynamic behavior, the material of the generic component that is manufactured must have a structure that is as much as possible homogeneous, uniform and free from cracks.

The technological process that allows to obtain such characteristics is hot pressing, which however can be applied only to a limited range of materials, which include steel, brass, copper, et cetera.

In the background art, if lighter components, for example made of aluminum, are manufactured, in view of the characteristics of aluminum such components can be provided only by means of a pressure die-casting process, which does not ensure lack of cracks and homogeneity of the material.

### SUMMARY OF THE INVENTION

The aim of the present invention is to eliminate the drawback cited above, by providing a hot pressing process, particularly for providing metal unions for pneumatic, hydraulic and fluid-operated circuits, that allows to use aluminum to obtain components that can be used in pneumatic and/or hydraulic systems with high operating pressures.

Within this aim, an object of the present invention is to provide a hot pressing process that allows to obtain components with material that is structurally homogeneous and free from cracks.

Another object of the present invention is to provide a hot pressing process to obtain aluminum components whose mechanical performance and dynamic behavior are comparable to those of components made of more traditional materials, such as for example brass and steel alloys.

Another object of the present invention is to provide a particular aluminum alloy that allows hot pressing.

This aim and these and other objects, which will become better apparent hereinafter, are achieved by a hot pressing process, particularly for providing metal unions for pneumatic, hydraulic and fluid-operated circuits, and by the resulting metal union, characterized in that it comprises:
a step of preheating aluminum alloy bars,
a step of pressing the part,
a thermal hardening treatment, and
a thermal treatment for artificial aging.

### BRIEF DESCRIPTION OF THE DRAWINGS

Further characteristics and advantages of the present invention will become better apparent from the description of a preferred but not exclusive embodiment of a hot pressing process, particularly for providing metal unions for pneumatic, hydraulic and fluid-operated circuits, according to the invention, illustrated by way of non-limiting example in the accompanying drawings, wherein:

FIG. 1 is a block diagram of the steps of an embodiment of a hot pressing process for aluminum components according to the present invention;

FIG. 2 is a partially sectional side elevation view of a first variation of a metal union that can be obtained with the hot pressing process shown in FIG. 1;

FIG. 3 is a partially sectional exploded view of the metal union shown in FIG. 2;

FIG. 4 is a partially sectional side elevation view of a second embodiment of a metal union that can be obtained with the hot pressing process shown in FIG. 1;

FIG. 5 is a partially sectional exploded view of the metal union shown in FIG. 4;

FIG. 6 is a view of the locking nut of the union shown in FIG. 4;

FIG. 7 is a sectional view of the locking nut shown in FIG. 6, taken along the line VII-VII.

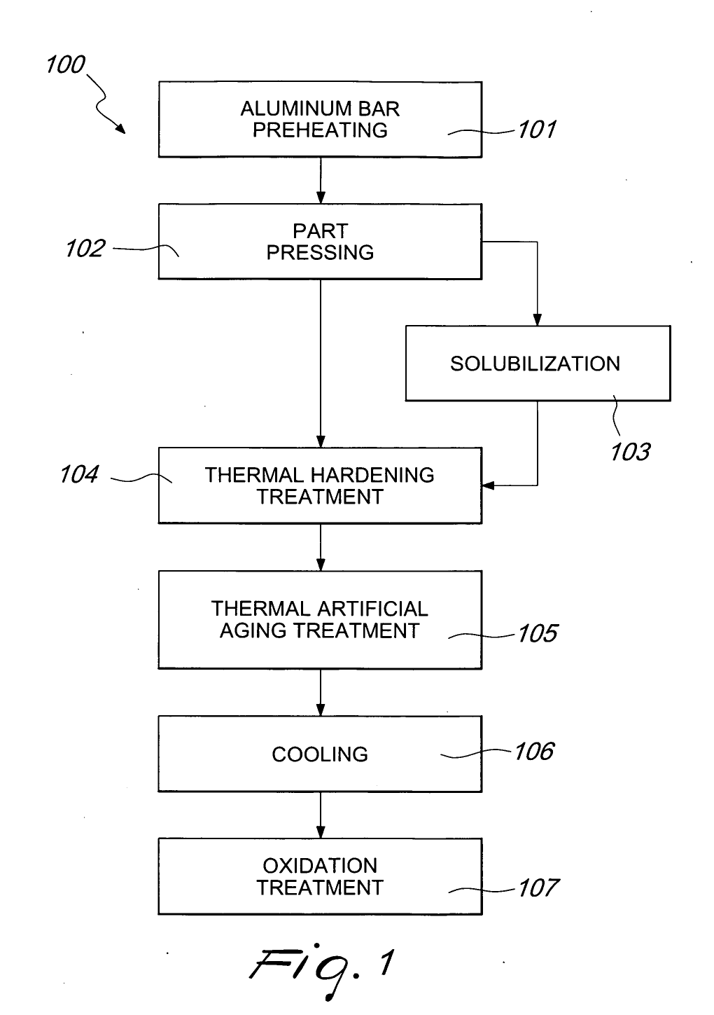

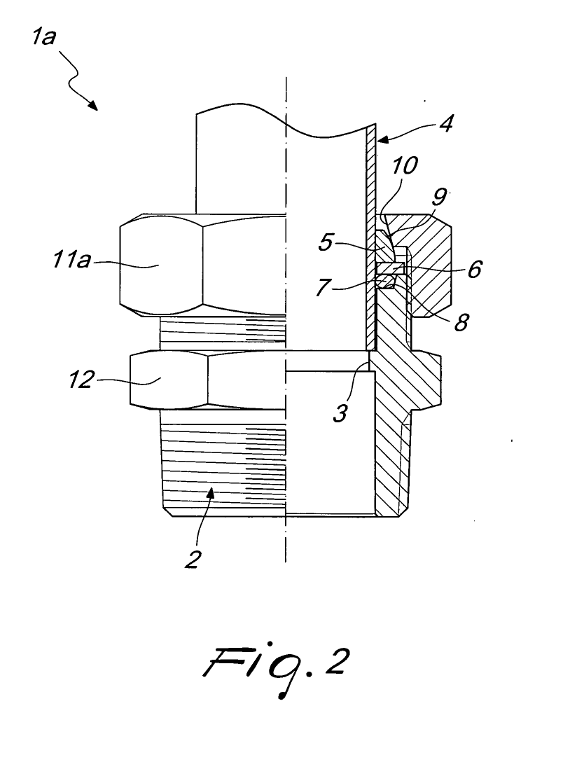

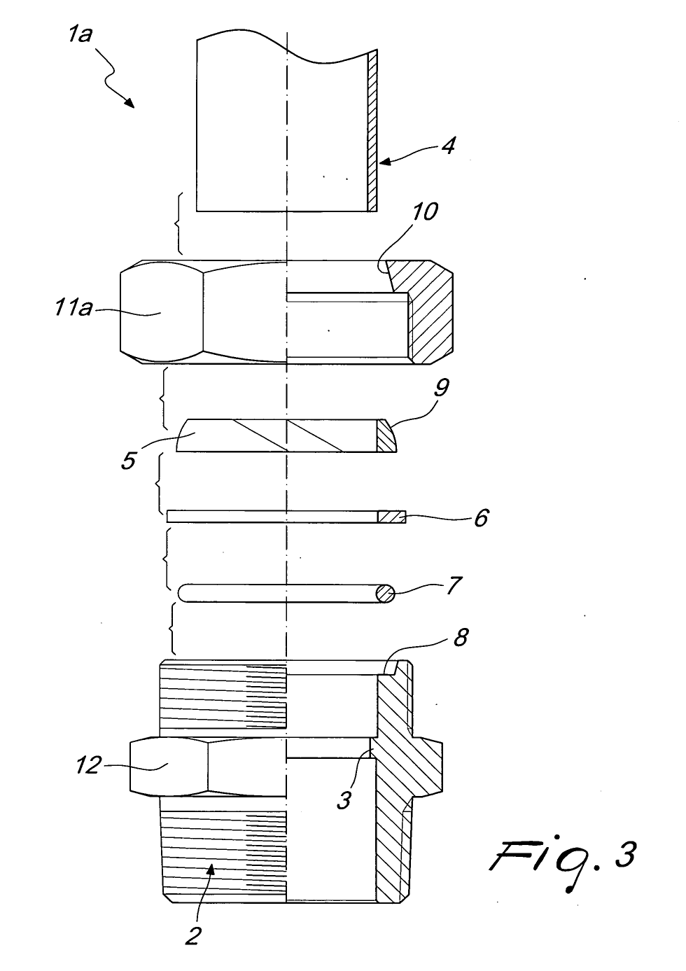

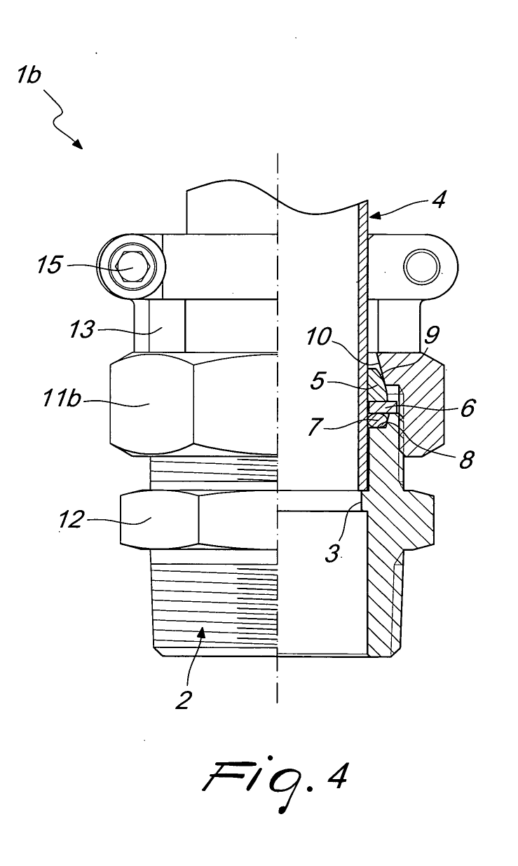

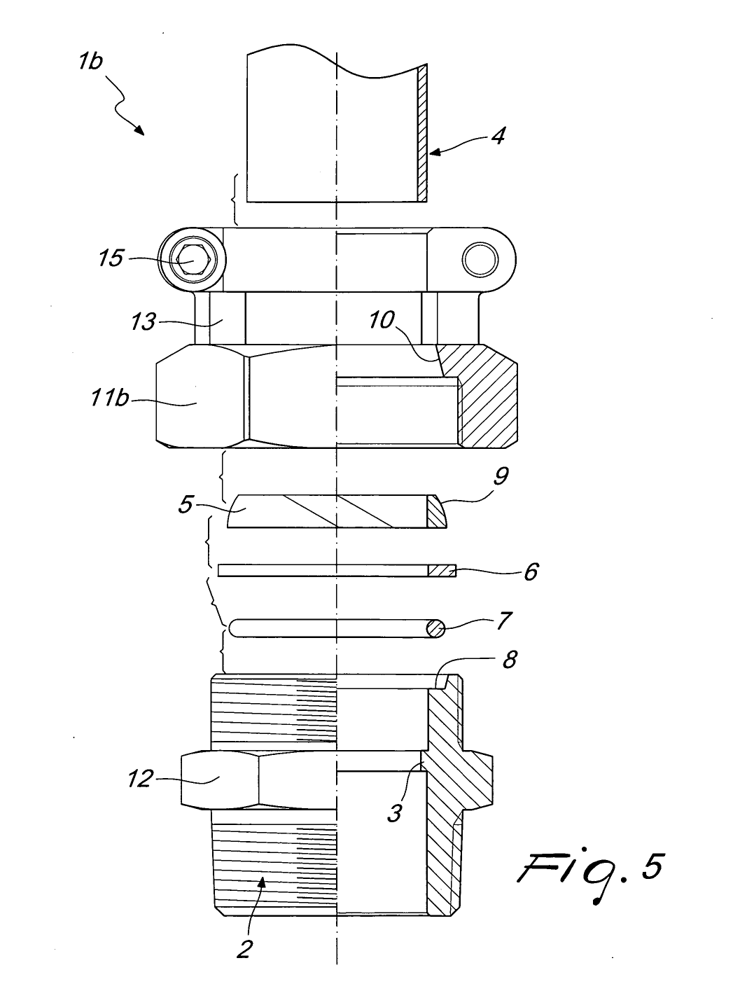

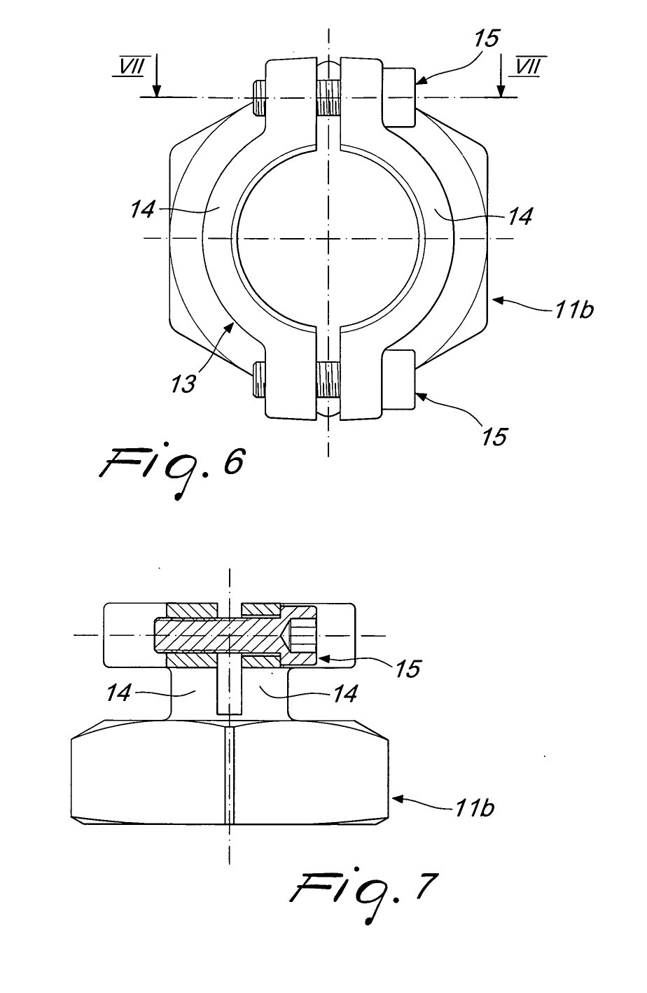

### DESCRIPTION OF THE PREFERRED EMBODIMENTS

With reference to the figures, the hot pressing process, particularly for providing metal unions for pneumatic, hydraulic and fluid-operated circuits, generally designated by the reference numeral 100, comprises a step 101 of preheating aluminum alloy bars in a first furnace at a temperature ranging substantially from 430° C. to 470° C., so that such temperature is uniform over the entire section of the bars.

A step 102 of pressing the part starting from the previously heated bars is then provided.

More specifically, the generic part can consist of a metal union for pneumatic, hydraulic and fluid-operated circuits provided in a plurality of variations, which will be described hereinafter.

After pressing the part, one proceeds with a step 103 known as solubilization. In this step 103, a second preheating of the metal unions in a second furnace to a solubilization temperature ranging substantially from 515° C. to 525° C. is provided for a minimum time substantially equal to 2 hours, and then a thermal hardening treatment 104 is performed which comprises an immersion of the metal unions in a bath of water preferably at ambient temperature.

With the cited solubilization temperatures, the immersion of the metal unions in the bath must be performed within 30 seconds of the solubilization step 103, with the bath at a maximum temperature that is substantially lower than 40° C.

As an alternative, immersion of the metal unions in the bath can be performed directly after the pressing step 102. In this case, the step 101 of preheating the bars occurs at a temperature ranging substantially from 480° C. to 500° C. for a minimum time that is substantially equal to 2 hours.

It must be specified that according to the invention, the standard cycle is the one that provides for the solubilization step 103. The elimination of this step can be seen as a modification to the standard cycle and is feasible only by maintaining a higher temperature in the preheating step 101.

In any case, after the thermal hardening treatment 104, after a waiting interval ranging from 2 to 3 hours, a thermal treatment for artificial aging 105 is provided which comprises keeping the metal unions in a third furnace at a uniform temperature ranging from 135° C. to 145° C. for substantially 8 hours.

Finally, a cooling step 106 is provided after the thermal treatment 105 and can be performed according to traditional criteria.

To ensure maximum resistance to corrosion caused by exposure to atmospheric agents, a treatment 107 of anode oxidation is provided on the metal unions and generates the oxidation of a thin surface layer of the metal unions, thus ensuring corrosion protection of the underlying material and determining, as a direct consequence, a considerable increase in the life of the metal union.

More precisely, the anode oxidation treatment 107 provides for a first step of protective anode oxidation, which oxidizes for a thickness of approximately 15 microns the surface of the part according to the UNI4522 standard, and a second step of oxide coloring in order to give the metal union the desired color.

The described hot pressing process 100 can be applied to several aluminum alloys and in particular is optimized for the use of a particular aluminum alloy known as AL2, since it is the one that ensures the best physical/mechanical quality of the pressed parts.

More precisely, the chemical composition of the aluminum alloy AL2 is as follows:
silicon, with a percentage by weight ranging substantially from 0.6% to 1.4%,
iron, with a percentage by weight substantially equal to 0.7%,
copper, with a percentage by weight ranging substantially from 0.2% to 0.5%,
manganese, with a percentage by weight ranging substantially from 0.2% to 1.0%,
magnesium, with a percentage by weight ranging substantially from 0.6% to 1.2%,
chromium, with a percentage by weight substantially equal to 0.3%,
zinc, with a percentage by weight substantially equal to 0.3%,
titanium, with a percentage by weight substantially equal to 0.2%,
lead, with a percentage by weight substantially equal to 0.4%,
bismuth, with a percentage by weight ranging substantially from 0.5% to 1.5%,
aluminum for the remainder.

The components obtained with the AL2 alloy by means of the hot pressing process 100 have the following mechanical characteristics:
relative density 2.7 kg/dm³,
unit ultimate tensile strength 422 N/mm²,
unit yield strength 410 N/mm²,
Brinell hardness 110 HB.

More precisely, the use of the AL2 alloy allows to obtain components that have a surface hardness of 60 HB after the pressing step 102 and of 110 HB or 95 HB after the thermal treatment 105 for aging, respectively with or without the solubilization step 103.

The metal unions that can be obtained from the hot pressing process of the AL2 alloy can be of several kinds.

For example, two possible variations of these unions are the metal union 1a and the metal union 1b.

Both variations 1a and 1b comprise a main hollow body 2, which has a substantially axially symmetrical geometry and forms a cross-section 3 that is contracted radially for the abutment of a pipe 4 that can be inserted hermetically in the main body 2 and can be fixed thereto by way of retention means.

More precisely, the retention means comprise a locking ring 5, which is open and surrounds the pipe 4.

This locking ring 5 can be engaged by abutment against a compression washer 6, which is accommodated in a circular receptacle formed internally by the pipe 4 and externally by a nut 11a or 11b.

Both the locking ring 5 and the compression washer 6 can be made of a white or yellow zinc coated brass alloy. For example, the P—CuZn40Pb2 UNI5705-65 alloy can be used.

The tightness of the coupling between the metal union 1a or 1b and the pipe 4 is ensured by an annular gasket 7, which is elastically deformable and is interposed between the compression washer 6 and a base 8 of the receptacle.

Depending on the temperature range at which the entire metal union 1a or 1b must work, the annular gasket 7 can be made of different materials.

For example, for temperatures ranging from −30° C. to +150° C. it is possible to use, as a material of the annular gasket 7, a supernitrile mix; for temperatures ranging from −45° C. to +150° C. it is possible to use, as a material of the annular gasket 7, an FPM mix (known commercially as Viton®); and finally, for temperatures ranging from −45° C. to +110° C. it is possible to use a nitrile mix as a material of the annular gasket 7.

The two variations 1a and 1b of the metal unions that can be obtained by means of the hot pressing process 100 of the AL2 alloy differ substantially in the means for retention with the pipe 4.

More precisely, the locking ring 5 of both variations 1a and 1b defines a substantially spherical outer surface 9, which can engage a substantially conical inner surface 10 of the locking nut 11a or 11b, depending on the variation being referenced, which can be screwed externally onto the main body 2.

In order to ensure a safe grip during fastening of the ring 5 on the pipe 4, in both variations 1a and 1b there is a radially wider cross-section 12 of the main hollow body that has a hexagonal profile for engagement with tools.

Moreover, other variations of the metal unions of the angular type can be provided. For example, the metal union can be substantially L-shaped or otherwise curvilinear, allowing the correct fastening of the ring 5 on the pipe 4 without the aid of the radially expanded cross-section 12, since the blended or inclined portion of the union can be locked easily, allowing the screwing of the nut 11a or 11b.

As regards the second variation 1b of the metal union, the retention means of the variation 1b differ from those of the variation 1a due to the presence of a locking band 13, which is jointly coupled to the locking nut 11b and forms at least two side walls 14 that can partially wrap around the pipe 4 and can be mutually closed thereon by way of screw means 15.

In practice it has been found that the hot pressing process, particularly for providing metal unions for pneumatic, hydraulic and fluid-operated circuits, according to the present invention, fully achieves the intended aim and objects, since it allows to provide aluminum unions particularly for pneumatic, hydraulic and fluid-operated use that are subjected to high pressure.

Another advantage of the hot pressing process according to the present invention consists in that the aluminum unions that can be obtained have mechanical strength properties that can be compared to unions made of brass.

A further advantage of the hot pressing process according to the present invention consists in that the aluminum unions that can be obtained have a better corrosion resistance than white zinc-coated brass.

Another advantage of the hot pressing process according to the present invention consists in that the aluminum unions that can be obtained are distinctly lighter than unions made of steel and those made of brass.

The hot pressing process, particularly for providing metal unions for pneumatic, hydraulic and fluid-operated circuits, and the metal unions and the composition of the aluminum alloy known as AL2, thus conceived, are susceptible of numerous modifications and variations, all of which are within the scope of the inventive concept.

Moreover, all the details may be replaced with other technically equivalent elements.

In practice, the materials used, so long as they are compatible with the specific use, as well as the contingent shapes and dimensions, may be any according to requirements and to the state of the art.

The disclosures in EPA No. 08425525 from which this application claims priority are incorporated herein by reference.

What is claimed is:

1. A hot pressing process for providing metal unions for pneumatic, hydraulic and fluid-operated circuits, comprising:
a step of preheating aluminum alloy bars,
a step of pressing the part comprising the hot pressing of said bars to obtain metal unions for pneumatic, hydraulic and fluid-operated circuits, said metal unions comprising a main hollow body and a locking nut for being screwed externally onto said main hollow body for retention of a pipe, said hot pressing being performed after said step of preheating aluminum alloy bars and including pressing the part starting from the previously heated bars,
a thermal hardening treatment, and
a thermal treatment for artificial aging.

2. The hot pressing process according to the claim 1, wherein said aluminum alloy comprises:
silicon, with a percentage by weight ranging from 0.6% to 1.4%,
iron, with a percentage by weight equal to 0.7%,
copper, with a percentage by weight ranging from 0.2% to 0.5%,
manganese, with a percentage by weight ranging from 0.2% to 1.0%,
magnesium, with a percentage by weight ranging from 0.6% to 1.2%,
chromium, with a percentage by weight equal to 0.3%,
zinc, with a percentage by weight equal to 0.3%,
titanium, with a percentage by weight equal to 0.2%,
lead, with a percentage by weight equal to 0.4%,
bismuth, with a percentage by weight ranging from 0.5% to 1.5%,
aluminum for the remainder.

3. The hot pressing process according to claim 1, wherein said step of preheating aluminum alloy bars comprises a first preheating of said bars in a first furnace to a temperature ranging from 430° C. to 470° C. which is uniform over the entire cross-section of said bars.

4. The hot pressing process according to claim 1, further comprising a step of solubilization of the pressed part, which comprises a second preheating of said metal unions in a second furnace at a solubilization temperature that ranges from 515° C. to 525° C. for a minimum time of substantially 2 hours, said second preheating being performed after said part pressing step.

5. The hot pressing process according to claim 4, wherein said thermal hardening treatment comprises an immersion of said metal unions in a water bath preferably at ambient temperature, said immersion of said metal unions in said bath being performed within 30 seconds of said step of solubilization of the pressed part with said bath at a maximum temperature that is lower than 40° C.

6. The hot pressing process according to claim 1, wherein said step of preheating aluminum alloy bars comprises a first preheating of said bars in a first furnace at a temperature ranging from 480° C. to 500° C. for a minimum time equal to 2 hours.

7. The hot pressing process according to claim 6, wherein said thermal hardening treatment (104) comprises an immersion of said metal unions in a water bath preferably at ambient temperature, said immersion of said metal unions in said bath being performed directly after said step (102) of pressing the part.

8. The hot pressing process according to claim 5, wherein said thermal treatment for artificial aging comprises keeping said metal unions in a third furnace at a uniform temperature ranging from 135° C. to 145° C. for 8 hours, said retention of said metal unions in said third furnace being performed after said thermal hardening treatment after a waiting interval ranging from 2 hours to 3 hours.

9. The hot pressing process according to claim 8, further comprising a treatment of anode oxidation of said metal unions.

10. The hot pressing process according to claim 9, wherein said anode oxidation treatment comprises the oxidation of a thin surface layer of said metal unions for protection against corrosion.

11. The hot pressing process according to claim 7, wherein said thermal treatment for artificial aging comprises keeping said metal unions in a third furnace at a uniform temperature ranging from 135° C. to 145° C. for 8 hours, said retention of said metal unions in said third furnace being performed after said thermal hardening treatment after a waiting interval ranging from 2 hours to 3 hours.

12. The hot pressing process according to claim 11, further comprising a treatment of anode oxidation of said metal unions.

13. The hot pressing process according to claim 12, wherein said anode oxidation treatment comprises the oxidation of a thin surface layer of said metal unions for protection against corrosion:

14. A metal union for pneumatic, hydraulic and fluid-operated circuits, comprising a main hollow body and a locking nut for being screwed externally onto said main hollow body for retention of a pipe, said metal union being made of an aluminum alloy that comprises:
silicon, with a percentage by weight ranging from 0.6% to 1.4%,
iron, with a percentage by weight equal to 0.7%,
copper, with a percentage by weight ranging from 0.2% to 0.5%,
manganese, with a percentage by weight ranging from 0.2% to 1.0%,
magnesium, with a percentage by weight ranging from 0.6% to 1.2%,
chromium, with a percentage by weight equal to 0.3%,
zinc, with a percentage by weight equal to 0.3%,
titanium, with a percentage by weight equal to 0.2%,
lead, with a percentage by weight equal to 0.4%,
bismuth, with a percentage by weight ranging from 0.5% to 1.5%,
aluminum for the remainder.
